(19) United States
(12) Patent Application Publication
(10) Pub. No.: US 2025/0213987 A1
(43) Pub. Date: Jul. 3, 2025

(54) CLIENT-SERVER ARCHITECTURE FOR A REAL-TIME STRATEGY VIDEO GAME

(71) Applicant: Tencent America LLC, Palo Alto, CA (US)

(72) Inventor: Michael SKACAL, Palo Alto, CA (US)

(73) Assignee: Tencent America LLC, Palo Alto, CA (US)

(21) Appl. No.: 18/402,146

(22) Filed: Jan. 2, 2024

(51) Int. Cl. A63F 13/75; A63F 13/34; A63F 13/355; A63F 13/822

(52) U.S. Cl. CPC A63F 13/75; A63F 13/34; A63F 13/355; A63F 13/822; A63F 2300/538

(57) ABSTRACT

A method is provided for improving multiplayer user experience in an online video game utilizing a lockstep engine. The method includes receiving user input information from at least one of a plurality of users of a match of the video game that utilizes the lockstep engine. Each of the user input information from the at least one of the plurality of users being associated with a current frame of a plurality of frames of the lockstep engine based on the respective user input information being received within a current time interval of the current frame. The method also includes sending the current frame of the user input information irrespective of whether the user input information is received from each of the plurality of users within the current time interval. Clients no longer need to be in the game at the same time for the game to proceed.

### TECHNICAL FIELD

The present disclosure relates to improving multiplayer user experience in an online video game.

### BACKGROUND

A video game includes an electronic or digital game that involves human interaction with a user interface to generate visual and/or auditory feedback on a computing device. Video games can be played on various computing devices, including consoles, personal computers, and mobile devices, such as smartphones and tablets. Many video games can now be played online where a user can interactively play against or with one or more other users over the Internet. In addition, an online user may also participate in these online matches as spectators of both live matches or already completed matches.

Multiplayer video games may be played over a network, for example using a peer-to-peer architecture or a client-server architecture. In a peer-to-peer architecture, clients may communicate directly with each other without a dedicated server. The peer-to-peer network, for example, is a decentralized network where each device, or peer, can act as both a client and a server. By contrast, in a client-server architecture, for example, communications are sent via a dedicated server layer for distribution to the clients.

There are various advantages and disadvantages to consider in determining whether to implement a peer-to-peer architecture or a client-server architecture in an online video game. Some advantages of utilizing a peer-to-peer architecture in favor of a client-server architecture may include a lower cost since a peer-to-peer architecture can run entirely on client devices and also more stability as players are not reliant on a server. Some disadvantages of the peer-to-peer architecture as compared to the client-server architecture may include difficulty implementing a solid peer-to-peer architecture versus a client-server architecture, difficulty in preventing cheating due to no neutral authority (e.g., a neutral server) that governs the game, difficulty scaling due to the network and computational requirements being too high to handle on client devices on a large scale, and greater latency due to the network infrastructure that peer-to-peer connections are routed through (e.g., “the last mile internet”) having slower upload speeds and higher packet loss.

Some advantages of using a client-server architecture over a peer-to-peer architecture is that the client-server architecture is easier to implement and can scale well. Latency may be lower due to some client-server setups having access to better network infrastructure via datacenter connections. Some disadvantages of the client-server architecture may include the additional cost to run and maintain servers and that every player is reliant on the server since the server is a central point of failure for all clients. As an example, if the server goes down or has stability issues then that will translate into downtime or instability of multiple functionality on all clients.

A real-time strategy (RTS) game may use a lockstep engine. With a lockstep engine, for example, the clients all run the exact same code with the exact same parameters and inputs. Accordingly, in an exemplary lockstep engine, each player requires input from every other player in a simulation before the game may move forward. This means that the game cannot move forward if inputs are not received by all players. A main drawback of a lockstep engine is that if a single client is lagging and cannot enter in an input, then the whole game must pause until the lagging client enters their input. This can ruin the online user experience of one or more players in an online video game and can make playing online matches frustrating since their experience is affected by other players. In addition, some players may exploit this principle by purposefully not sending in their inputs to slow down or ruin the experience for other players.

Thus, it may be beneficial to leverage advantages of using a client-server architecture in a lockstep engine in online multiplayer video games to reduce delays in a video game that utilizes a lockstep engine.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

The present disclosure includes a method and an apparatus of improving a user experience for a player in an online multiplayer game. In another example, a method and apparatus allows developers to update game data. The game data may be updated while a match is in progress and the updates may be reflected immediately without having the players restart the game and/or download and install client patches.

An aspect of this subject matter described is implemented in a method of a video game utilizing a lockstep engine, the method includes receiving user input information from at least one of a plurality of users of a match of the video game that utilizes the lockstep engine. Each of the user input information from the at least one of the plurality of users may be associated with a current frame of a plurality of frames of the lockstep engine based on the respective user input information being received within a current time interval of the current frame. The method also includes sending the current frame of the user input information irrespective of whether the user input information is received from each of the plurality of users within the current time interval.

A further aspect of the subject matter described in this disclosure can be implemented in an apparatus for a video game utilizing a lockstep engine. The apparatus includes processing circuitry configured to receive user input information from at least one of a plurality of users of a match of the video game that utilizes the lockstep engine. Each of the user input information from the at least one of the plurality of users may be associated with a current frame of a plurality of frames of the lockstep engine based on the respective user input information being received within a current time interval of the current frame. The processing circuitry is further configured to send the current frame of the user input information irrespective of whether the user input information is received from each of the plurality of users within the current time interval.

Yet another aspect of the subject matter described in this disclosure can be implemented in a non-transitory computer-readable storage medium storing computer-readable instructions thereon, which, when executed by processing circuitry, cause the processing circuitry to perform a method of a video game utilizing a lockstep engine. The method includes receive user input information from at least one of a plurality of users of a match of the video game that utilizes the lockstep engine. Each of the user input information from the at least one of the plurality of users may be associated with a current frame of a plurality of frames of the lockstep engine based on the respective user input information being received within a current time interval of the current frame. The method also includes sending the current frame of the user input information irrespective of whether the user input information is received from each of the plurality of users within the current time interval.

An aspect of this subject matter described is implemented in a method of a video game utilizing a lockstep engine, the method includes transmitting, to a server, a request to join a match after the match has started. The match may be in the video game that utilizes the lockstep game engine. The method also includes receiving, in response to the request to join, game state information of the match for a plurality of time intervals of the match of the video game. The game state information may include information for each of a plurality of time intervals of the lockstep game engine. The method further includes rendering a plurality of video frames of the match in the video game based on the game state information for each of the plurality of time intervals.

A further aspect of the subject matter described in this disclosure can be implemented in an apparatus for a video game utilizing a lockstep engine. The apparatus includes processing circuitry configured to transmit, to a server, a request to join a match after the match has started. The match may be in the video game that utilizes the lockstep game engine. The processing circuitry is also configured to receive, in response to the request to join, game state information of the match for a plurality of time intervals of the match of the video game. The game state information may include information for each of a plurality of time intervals of the lockstep game engine. The processing circuitry may further be configured to render a plurality of video frames of the match in the video game based on the game state information for each of the plurality of time intervals.

Yet a further aspect of the subject matter described in this disclosure can be implemented in a non-transitory computer-readable storage medium storing computer-readable instructions thereon, which, when executed by processing circuitry, cause the processing circuitry to perform a method of video game utilizing a lockstep engine. The method includes transmitting, to a server, a request to join a match after the match has started. The match may be in the video game that utilizes the lockstep game engine. The method also includes receiving, in response to the request to join, game state information of the match for a plurality of time intervals of the match of the video game. The game state information may include information for each of a plurality of time intervals of the lockstep game engine. The method further includes rendering a plurality of video frames of the match in the video game based on the game state information for each of the plurality of time intervals.

An aspect of this subject matter described is implemented in a method of receiving a video game update, the method includes running, by a processor, a video game that utilizes a lockstep engine. The method also includes receiving, from a server, updated configuration information associated with a particular frame of a plurality of frames of the lockstep engine. The updated configuration information may include a change to an attribute of a game element of the video game at the particular frame. The method further includes updating, while the video game is running, the attribute of the game element of the video game at the particular frame.

A further aspect of the subject matter described in this disclosure can be implemented in an apparatus receiving a video game update. The apparatus includes processing circuitry configured to run, by a processor, a video game that utilizes a lockstep engine. The processing circuitry is also configured to receive, from a server, updated configuration information associated with a particular frame of a plurality of frames of the lockstep engine. The updated configuration information may include a change to an attribute of a game element of the video game at the particular frame. The processing circuitry is further configured to update, while the video game is running, the attribute of the game element of the video game at the particular frame.

Yet another aspect of the subject matter described in this disclosure can be implemented in a non-transitory computer-readable storage medium storing computer-readable instructions thereon, which, when executed by processing circuitry, cause the processing circuitry to perform a method of receiving a video game update. The method includes running, by a processor, a video game that utilizes a lockstep engine. The method also includes receiving, from a server, updated configuration information associated with a particular frame of a plurality of frames of the lockstep engine. The updated configuration information may include a change to an attribute of a game element of the video game at the particular frame. The method further includes updating, while the video game is running, the attribute of the game element of the video game at the particular frame.

To accomplish the foregoing and related ends, the one or more aspects include the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is not intended to describe all such aspects and their equivalents.

### BRIEF DESCRIPTION OF DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 is a block diagram of an exemplary computing device.

FIG. 2A is a diagram of an exemplary RTS lockstep engine running on a peer-to-peer architecture.

FIG. 2B is a diagram of an exemplary RTS lockstep engine running on a client-server architecture.

FIG. 3 is a call flow diagram of a video game architecture utilizing a RTS lockstep engine in accordance with one or more techniques of this disclosure.

FIG. 4 is a call flow diagram of a user joining a game mid-match in accordance with one or more techniques of this disclosure.

FIG. 5 is a flowchart of a method of utilizing a RTS lockstep engine in a video game in accordance with one or more techniques of this disclosure.

FIG. 6 is a flowchart of another method of utilizing a RTS lockstep engine in a video game in accordance with one or more techniques of this disclosure.

FIG. 7 is a flowchart of a method of live updating game data during a match in a video game in accordance with one or more techniques of this disclosure.

Like reference numbers and designations in the various drawings indicate like elements.

### DETAILED DESCRIPTION

The following description is directed to some exemplary aspects for the purposes of describing innovative aspects of this disclosure. However, a person having ordinary skill in the art will readily recognize that the teachings herein can be applied in a multitude of different ways.

Users, or players, may face each other in a competitive player versus player (PvP) type game, for example in a video game (e.g., a computer game). A popular type of PVP game that can be played online is a real-time strategy (RTS) game. RTS is a genre of computer games that is similar to a battle stimulation. In an RTS game, a player controls one or more units (e.g., soldiers, engineers, medics, tanks, ships, etc.) by issuing orders in real-time to gather resources, build an infrastructure, generate new units and buildings, upgrade units and buildings, and/or destroy forces of an opponent. In some RTS games, a player is able to view the battle field from a bird's eye (top-down) perspective. The “real-time” aspect of RTS comes from the fact that players do not incrementally take turns. Instead, the players act simultaneously to position and maneuver units and/or buildings under their control to win a game. Criteria for winning the game may include destroying a core building (e.g., a command center), buildings belonging to their opponent, and/or completing an objective.

Many RTS games are built using a lockstep engine because RTS games may tolerate network latency better than games such as fighting or sports games. In an example of a lockstep engine, video game clients exchange only input values. For each tick (e.g., a lockstep frame) to be simulated locally on each client of a player, all input values from each client should arrive at a particular machine such as a server, which distributes the input values to the clients of the respective players.

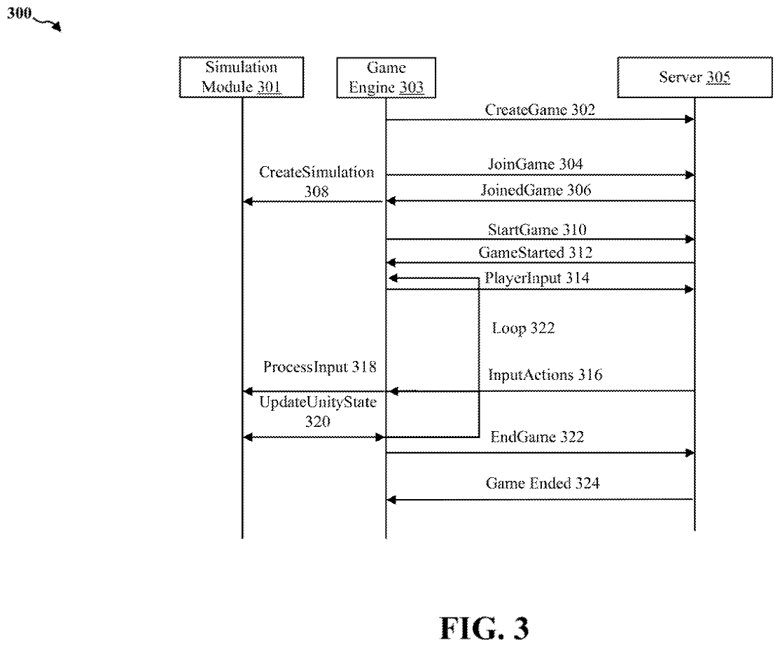

A requirement for a lockstep engine is that a game simulation (e.g., the simulation module 301 shown in FIG. 3) needs to maintain strict bitwise determinism. Since the lockstep engine only synchronizes inputs, the game simulation must calculate identical results on each client given identical inputs. Otherwise, the game simulations will desynchronize, diverge, and eventually drift apart, which results in games on the clients that can look entirely different from one another.

Lockstep engines are a popular choice for online RTS games because, RTS games are not particularly sensitive to input latency and are deterministic. In RTS games, input delays do not negatively impact the experience for players as much as other genres of video games. Input delay may be unacceptable for other types of games due to the demanding response times required for fighting games and first person shooting games. By comparison to first person shooting games, RTS games transmit less data per tick such as “player 1 is constructing a barracks at this location” or “player 1 commanded unit 6 to move to this location.”

An example of a specific lockstep engine is a Lockstep RTS Engine (LRE) that was designed for three-dimensional (3D) RTS games with lockstep simulations. The LRE includes a deterministic two-dimensional (2D) physics engine, pathfinding, behavior system, and more. In addition, another advantage of a lockstep system is that a replay of a game section can be run from a small amount of data, such as from only the sequence of input values for all game clients. In some examples, the data may be as little as 50 kilobytes.

In particular, RTS games are generally implemented utilizing a lockstep engine. The idea behind a lockstep engine is that every player shares their input with every other player such that the simulation can be run on each player's own client with identical input to produce identical output. The lockstep engine is an implementation of a deterministic protocol, where each subsequent game frame is processed only once inputs and actions of each player are known for the frame. Specifically, the lockstep engine operates under a deterministic lockstep method where rather than sending game state updates (e.g., a position and speed of the player's units), the player's control inputs are sent instead, and the other clients process those inputs to determine how it affects the game state.

As an example, if a player is shooting an arrow, the client would need to send not only the speed and position of the player, but also the arrow to all other clients. By contrast, in deterministic lockstep, the client simply sends the fact that the player has pressed the “fire arrow” button, and the other clients process that input to determine how to spawn and arrow and process the action and motion of the arrow. The “deterministic” part of the name means that in order for the game to remain synchronized by using only the input data, each client must be able to reliably reproduce the same game state. If a particular input says jump for a virtual unit, each client must have that virtual unit perform a jump and have the virtual unit move in exactly the same way across all clients. As another example, if the input says “fire an arrow,” the arrow needs to fly the same path across all clients. Any small difference in result could cause the game to desynchronize.

In a lockstep engine, it may be challenging to provide a stable online user experience for all players if even one of the players does not have a stable internet connection. As mentioned above, video games that utilize a lockstep engine require that all players submit their inputs into a simulation before the game can proceed. Accordingly, if a single player experiences any delays in their internet connection and cannot send their input on time, then this delay in the pathway will result in pausing the game for every player since the lockstep engine must wait for everyone to send input data for the current frame (or game turn) to each other before the game can move forward. In other words, the game cannot proceed until all user inputs are received and, as such, the game may be paused for all remaining users such that a prompt such as “waiting for player” may be displayed until all user inputs are received. Accordingly, players may exploit the RTS engine by purposefully not sending in their turn data to frustrate or ruin the experience for other players. Furthermore, in some lockstep RTS video games, there is no ability for a disconnected user to rejoin a match or a spectator to join a match once the match has started.

Aspects of the present disclosure include a method of improving a multiplayer user experience in an online video game. For example, the game architecture described in the present disclosure allows users to utilize advantages of a client-server architecture and a lockstep engine. By taking a client-server approach, the lockstep engine does not need a verified input from every user. Instead, if a user does not send an input then the game server will close the loop on that player's behalf by submitting no inputs for that user. This allows the present disclosure to eliminate a requirement for lockstep engines to receive inputs from each player before the game can proceed. It should be noted that the client-server architecture does not require that a client device and server device be separate devices. While the client device and server device may be separate, it should be noted that the server functionality may be delegated to, or otherwise implemented by, one or more of the client devices in other examples.

A first benefit of the present disclosure is to reduce adverse impacts to the experience of other users due to an unstable network connection or one or more of the users purposefully withholding inputs. In addition, users may easily disconnect and reconnect to rejoin a match that is already in progress without impacting the other users. As an example, spectator users may also connect to matches that are already in progress. Furthermore, using the game architecture, video game developers may update game data while the match is still running and have those updates reflected immediately without the clients having to restart the game and/or download a client patch to receive the updates.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different system configurations, networks, interactive methods, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatuses and methods. These apparatuses and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing circuitry). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media, such as at least one non-transitory computer-readable storage medium. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

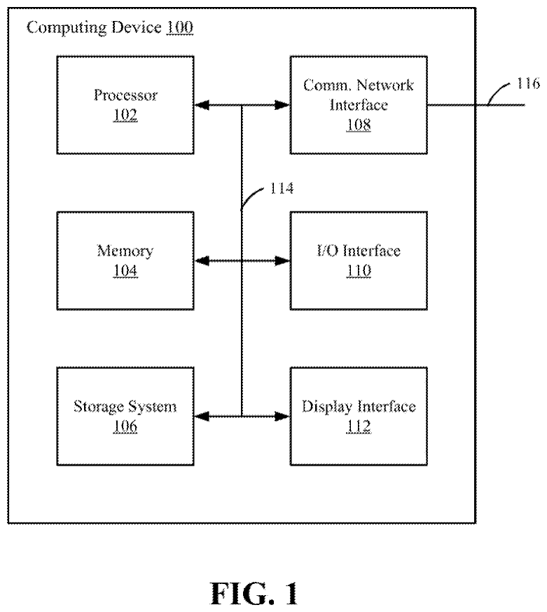

FIG. 1 is a block diagram of an exemplary computing device 100. A computing device 100 includes at least a processor 102, a memory system 104, a storage system 106, a communication network interface 108, an input/output (I/O) interface 110, and a display interface 112 communicatively coupled to a bus 114. The processor 102 is configured to execute executable instructions (e.g., programs). In some aspects, the processor 102 includes circuitry or any processor capable of processing the executable instructions.

As described herein, a device, such as the computing device 100, may refer to any user device, apparatus, or system configured to perform one or more techniques described herein. For example, a user device may be a client device, a computer (e.g., a personal computer (PC)), a desktop computer, a laptop computer, a tablet computer, a computer workstation, or a mainframe computer, a phone, a smart phone, a video game platform or console, a handheld device (e.g., a portable video game device or a personal digital assistant (PDA)), a wearable computing device (e.g., a smart watch), an augmented reality device, a virtual reality device, a display or display device, a television, a television set-top box, a network device, a digital media player, a video streaming device, a content streaming device, an in-car computer, or any other device configured to perform one or more techniques described herein. Processes herein may be described as performed by a particular component (e.g., a CPU), but, in further aspects, can be performed using other processing components configured to perform the described processes.

The computing device 100 may be any user device with a processor and memory. While many user devices on which to play video games are different, the user devices may share some common characteristics. For instance, the user devices may have some method of capturing user input such as a computer mouse, keyboard, remote control, touchscreen, game controller, or the like. In addition, the different user devices may also have some method of displaying a two-dimensional image using a display such as a TV screen or computer monitor (e.g., LED, LCD, or OLED) or touchscreen. In some devices, the user devices may have some method of displaying a three-dimensional image using a display such as a head-set display or augmented reality device. The user devices may have some form of processing CPU, although the capability often widely varies in terms of capability and performance. Further, in some aspects, the user devices may have a connection to the internet, such as an Ethernet connection, WiFi connection or mobile phone cell data connection.

In various aspects, one or more users may utilize their respective computing device to play one or more video games, including a computer game, mobile game, cloud game, or console game. The computing device 100 may display a virtual scene of a virtual environment with virtual units, virtual buildings, one or more user interfaces (UIs) or visual displays associated with the game. The user interfaces may be configured to receive user selections (e.g., user input) for displaying visual menus, selecting units for use in the game, or controlling virtual objects within an RTS game, for example. There may be any number of menus that provide opportunity for user selection via buttons, radio buttons, check boxes, sliders, text fields, selectable objects, moveable objects, and/or the like.

The memory system 104 is any memory configured to store data. Some examples of the memory system 104 are storage devices, such as random-access memory (RAM) or read-only memory (ROM). The memory system 104 can include a RAM cache. In various aspects, data is stored within the memory system 104. The data within the memory system 104 may be cleared or ultimately transferred to the storage system 106.

The storage system 106 is any storage configured to retrieve and store data. Some examples of the storage system 106 are flash drives, hard drives, optical drives, and/or magnetic tape. In some aspects, the computing device 100 includes a memory system 104 in the form of RAM and a storage system 106 in the form of flash data. Both the memory system 104 and the storage system 106 include computer readable media which may store instructions or programs that are executable by a computer processor including the processor 102.

The communication network interface 108 can be coupled to a network (e.g., communication network) via a link 116. The communication network interface 108 may support communication over an Ethernet connection, a serial connection, a parallel connection, or an ATA connection, for example. The communication network interface 108 may also support wireless communication (e.g., 802.11 a/b/g/n, WiMax). It will be apparent to those skilled in the art that the communication network interface 108 can support any number of wired and wireless standards.

The I/O interface 110 is any device that receives input from the user and outputs data. The display interface 112 is any device that is configured to output graphics and data to a display. In one example, the display interface 112 is a graphics adapter.

It will be appreciated by those skilled in the art that the hardware elements of the computing device 100 are not limited to those depicted in FIG. 1. The computing device 100 may include more or less hardware elements than those depicted. Further, hardware elements may share functionality and still be within various aspects described herein.

When designing a game with an online multiplayer aspect, game developers must choose a network architecture that works best for the intended purpose of the game. As mentioned above, the network architecture may be peer-to-peer based or client-server based, for example. Each network architecture has their own benefits and issues that developers should consider before deciding which network architecture to implement.

Client-server architectures are typically implemented in multiplayer games, especially in massive multiplayer online games (MMOGs). There are a multitude of resources to help developers implement the architecture and it can provide a more profitable business model compared to peer-to-peer architectures. However, client-server architectures are susceptible to network failure and bottlenecks on the server-side, which can cause poor playability and user experience for players. Client-server architectures are also more expensive to implement and maintain. Peer-to-peer architectures are often implemented in multiplayer games that do not require many players to be connected at once. Thus, they are often implemented in fighting games. Peer-to-peer architecture also provides a lower level of latency. However, their networks are not as secure or as consistent as client-server architectures.

As described in more detail, the basic idea of a lockstep engine is to abstract the game into a series of turns and a set of inputs (e.g., command messages) from each user. At the end of each turn, a server collects all inputs from the users and transmits the inputs to each user's client for processing before the beginning of the next turn. Thus, as long as all clients are starting from a common initial game state, each client will run the same exact set of inputs and turns as the game progresses.

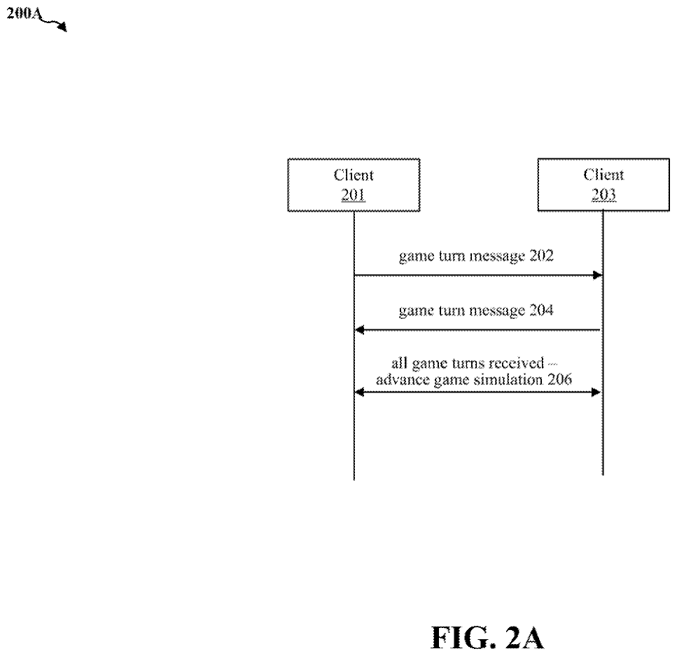

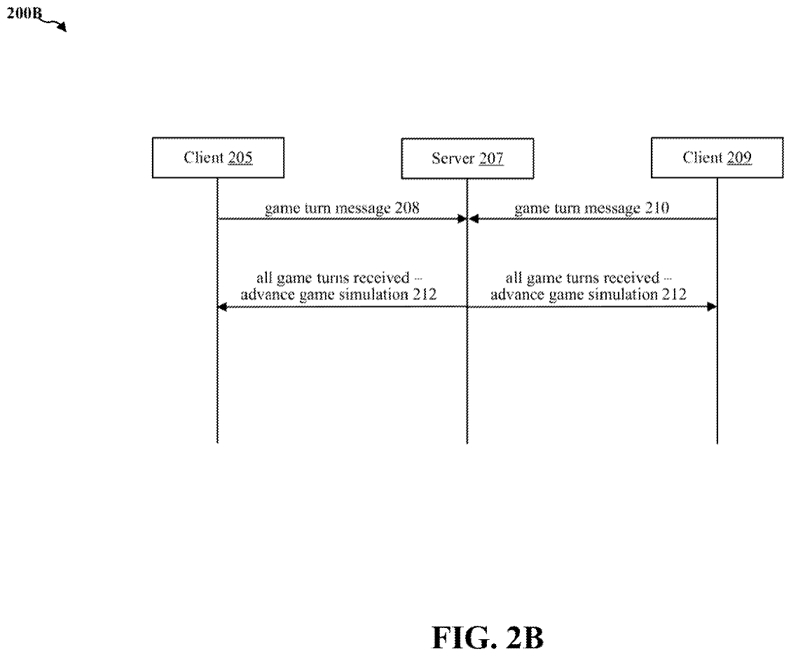

FIG. 2A is a call-flow diagram of an exemplary RTS lockstep engine running on a peer-to-peer architecture. While pertinent features are shown, those of ordinary skill in the art will appreciate from the present disclosure that various other features have not been illustrated for the sake of brevity and so as not to obscure more pertinent aspects of the example implementations disclosed herein.

In a peer-to-peer architecture, clients are connected with an arbitrary number of other clients such that there is no central point of control. Instead, the clients are used as resources to run and manage the game in a distributed fashion.

As shown in example 200A of FIG. 2A, the first client 201 and the second client 203 are connected to each other and there is no intermediary routing server. In order to make sure that each player is playing the same game, the clients all run the exact same code with the same parameters and inputs. For example, in a lockstep engine, if one player orders an army forward that command is issued to every other client and each client processes that command to move that army forward. The lockstep engine is particularly efficient for networking because only the player inputs (e.g., orders, build commands, etc.) are sent and take up very little space in the network packet. As an example, the player inputs may be as small as 50 kilobytes.

At step 202, the first client 201 transmits a game turn message (e.g., an input or command) to the second client 203 and, at step 204, the second client 203 also transmits a game turn message to the first client 201. At step 206, the game turn may advance because the first client 201 and the second client 203 can process all game turn messages and the game can move forward.

Although RTS games may be implemented with a RTS lockstep engine, there are some drawbacks to utilizing the RTS lockstep engine for RTS games. For example, since the lockstep engine must wait for every client to send their game turn (or current frame) before the game can move forward, any delays in this pathway can slow the game down for everyone. As a result, players may exploit this pathway to cause frustration to other players by purposefully not sending in their turn data, which can slow down the experience for everyone.

FIG. 2B is a call-flow diagram of an exemplary RTS lockstep engine running on a client-to-server architecture. While pertinent features are shown, those of ordinary skill in the art will appreciate from the present disclosure that various other features have not been illustrated for the sake of brevity and so as not to obscure more pertinent aspects of the example implementations disclosed herein.

In a client-server architecture, since game state is managed by a server alone, each client must sent their inputs to the server. The server then periodically updates the game state and sends the new game state back to the clients for rendering on their screens. In some examples, the server can be one or a cluster of dedicated machines that are usually maintained by the game provider.

As shown in example 200B of FIG. 2B, the first client 205 and the second client 209 both connect to an intermediary routing server 207. The intermediary routing server 207 is configured to manage, collect, and transmit user inputs from each client. At step 208, the first client 205 sends a game turn message (e.g., an input or command) to the server 207, and, at step 210, the client 209 also sends a game turn message to the server 207. At step 212, once all game turn messages are received at the intermediary routing server 207, the server 207 will collect game turn messages from all clients and transmit the game turn message to the first client 205 and the second client 209 such that the first client 205 and the second client 209 can process all game turn messages and the game can move forward.

However, there are also some drawbacks to utilizing a client-server architecture. For example, the server must send many more updates to each client than compared to a peer-to-peer architecture since every single unit's move, every bullet that is fired, and every health bar of each single unit needs to be correctly synchronized. In addition, a server also creates added expense for maintaining and running game servers.

FIG. 3 is a call flow diagram of a game architecture utilizing a RTS lockstep engine in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

Example 300 shows an example call flow diagram of a game flow for a video game that utilizes a RTS lockstep engine. Example 300 includes a simulation module 301 for managing ground truth of game information that is sent to all clients, a game engine 303 for processing inputs from the simulation module 301 and rendering graphics, and a server 305 for collecting and sending user input. In some examples, the game engine 303 may include a rendering module and an interaction module. Since the game engine 303 may be located on a local client of each player, each player will have their own game engine 303 in order to reconstruct the game to a previous state, a current state, or subsequent state.

In some examples, the simulation module 301 may process a completely non-visual version of the game. The simulation module 301 maintains true positions for all virtual objects in the virtual environment and the information for the game such as unit health, rules, etc. such that the simulation module 301 transmits the actual positions and inputs to game engine 303 of each player. The simulation module 301 may be local to each client of the user and will be identical for all users. In some examples, the simulation module 301 may be provided in one or more servers, for example in the case of a cloud game.

In some examples, the game engine 303 may be specific to each user. The respective game engines 303 of each player is configured to receive data from the simulation module 301 and update the visual renderings and representations of the virtual objects in the game on the client of the user. In some examples, the game engine 303 may be a Unity client.

In some examples, FlatBuffers is utilized as the data transport between the simulation module 301 to the game engine 303. FlatBuffers represent hierarchical data in a flat binary buffer in such a way that it may still be able to be accessed directly without parsing and/or unpacking.

In some aspects of the present disclosure, the server 305 is configured to manage game states (e.g., rules, configuration, unit data, inputs, commands, etc.). The server 305 may manage the entire game state or a subset of the game state. In some examples, the server 305 is where all the commands by the users are obtained and will release all player inputs in the game at an appropriate time. The server 305 is configured to ensure that each user command is replicated to the simulation module 301 of each user because the simulation module 301 has to be synchronized for the users. If the simulation modules goes out of sync, then there will be a de-sync error in the game. In some examples, the server 305 may be a Golang game server.

In some examples, Protocol Buffers (Protobuf) may be utilized as the data transport from the game engine 303 to the server 305. Protobuf provides a serialized format for packets of typed, structured data that are up to a few megabytes in size.

At step 302, the game engine 303 transmits a request to create a game to the server 305.

At step 304, the game engine 303 transmits a command to join a game to the server 305. In response, at step 306, the server 305 allows the game engine 303 to join the game. At step 308, the game engine 303 transmits a command to the simulation module 301 to create a simulation.

At step 310, the game engine 303 sends a command to the server 305 to start the game. At step 312, the server 305 responds by starting the game.

At step 314, the game engine 303 will transmit a player input to the server 305. Each separate game engine for each player will send their individual player inputs to the server 305. Since the game utilizes a lockstep engine, the server 305 is responsible for collecting each input from all players and then transmitting all received players commands for each individual game engine 303 to process. In a deterministic lockstep engine, clients of all players execute every other player's commands in the simulation on every machine in a synchronized manner or else the simulations will start to diverge and desync. After a tick (e.g., game turn or time slice) is over, at step 316, the server 305 will transmit input actions (e.g., game turn message 208, 210 from FIGS. 2A-2B) for all players to each client's game engine 303 to process. In some examples, the time slice corresponds to how often each turn should be processed. In some examples, the time slice corresponds to when player inputs should be released to the clients. As an example, a time slice may be 50 milliseconds (e.g., length of a game turn), which means that the game is expected to move forward every 50 milliseconds.

At step 318, the simulation module 301 will process inputs sent by the game engine 303. At step 320, the simulation module 301 will update the unity state at the game engine 303. At step 322, the steps 314-320 are repeated in a loop for each tick, time slice, or game turn, until the game is completed 324. In some examples, the time slice indicates how often each turn should be processed or when to release player inputs to the game. After each tick, time slice, or game turn, the server 305 will release the frame to all listening parties (e.g., or connections).

In some examples, the game is complete when a player destroys a core building (e.g., main base or command center), destroys all buildings belonging to an opponent, and/or completes an objective before the other player. Other ways a match may end include when a user is successful in securing or capturing enemy territory or resources, destroying specific assets, and/or creating certain resources or buildings first, which is generally limited by a condition to expend accumulated resources.

After the game is complete, at step 322, the game engine 303 transmits a request to end the game to the server 305. At step 324, the server 305 transmits a message to end the game to each game engine 303.

In some examples, game state information for one or more time points of the match may be stored. For example, the game state information may be as small as 100 kilobytes. The game engine 303 may use the state information for a time point before a desired replay time (e.g., a closest time point) as a starting point, and generate subsequent replay content based on user inputs after the time point of the state information. The game state information and/or user inputs may be used to allow a player to join a game, after the game has already started, or reconnect to a game after a disconnect in some aspects.

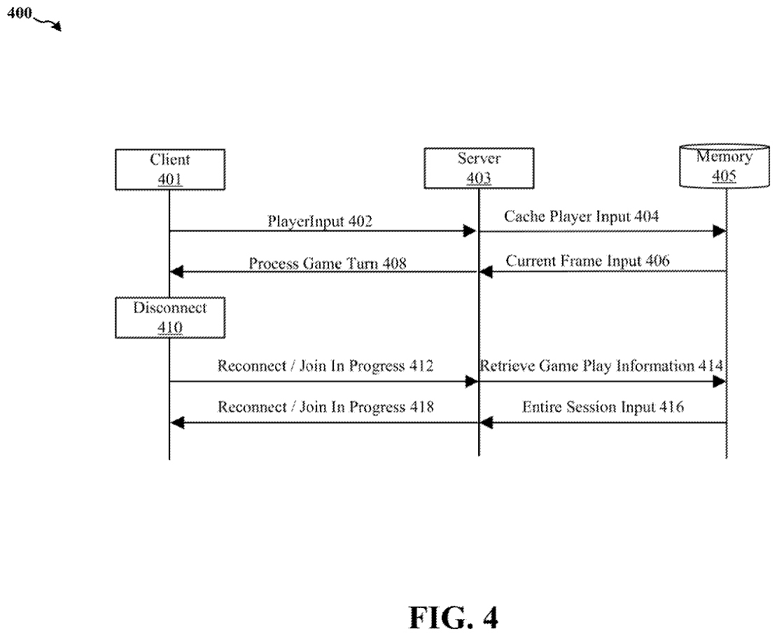

FIG. 4 is a call flow diagram of a user joining a match of a RTS game utilizing a RTS lockstep engine in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

The ability to reconnect quickly or allow users to spectate any games in progress helps to keep users engaged. For example, a user may want to play with their online friends, but their online friend is currently in a match. Generally, users do not like to be left idle and, as a result, may not wait for their online friend to finish. Instead, in the present disclosure, a waiting user may stay engaged by joining their online friend's match as a spectator. In addition, when the user decides to spectate their online friend's match, the user can be caught up quickly to the current state of the game and watch the game in real time. In some examples, the user may watch the match with a slight time delay (or other limitations may be applied to game play viewed by the user) in order to avoid sharing of information with players that can affect the game play.

Example 400 includes at least a client 401 corresponding to an individual user with a game engine, a server 403 for collecting all user input (e.g., game turn message 202, 204 from FIG. 2A, game turn message 208, 210 from FIG. 2B, and player input 314 shown in FIG. 3) and to transmit the user inputs to all clients when the game turn ends, and session storage in memory 405 for storing at least a session storage.

One of the advantages of utilizing a lockstep system is that a game can be run from only the sequence of input values for all game clients. In some RTS games, the RTS games may only store partial game state information (e.g., not storing game state information for every single frame due to file size and memory constraints) as index states and then use inputs between the index points to generate the replay through the game engine. The architecture described in the present disclosure, for example, can remove the need for using partial game state information and index states since the game engine can quickly use user inputs for an entirety of the game session to replay game state in some aspects.

Unlike some RTS games utilizing a lockstep engine, the server 403 can process the specifics of the RTS game as it relates to timing (e.g., when a tick, frame, or time slice) has ended. In one embodiment, the server 403 also maintains all player commands and inputs to allow disconnected users to reconnect to the game and new spectator users to connect to a match that is in progress. In some examples, the inputs may be cached and/or compressed before the inputs are stored. As described herein, the inputs may include player actions (e.g., generate a virtual unit, generate a virtual building at location x on the game map, or the like) and commands issued to virtual units (e.g., move virtual unit to location y on the game map, attack, defend, stop, or the like). The server 403 may store game state information for one or more frames, in addition to the inputs, to allow the client 401 to reconstruct a desired state of the RTS game more quickly.

At step 402, the client 401 transmits a player input (or command) to the server 403. At step 404, the server 403 caches all player inputs in a session storage in memory 405. At step 406, the session storage in memory 405 transmits current frame input to the server 403. In turn, at step 408, the server 403 transmits all the user inputs to the client 401 to advance the game turn such that the game turn is processed by the client 401 itself. For example, the client 401 processes the user inputs in the current frame input when received. In an example, the client 401 processes its own user input in response to receiving the current frame input from the server 403. Steps 402-408 ensure that each client will run the same exact set of inputs and turns. In other words, a deterministic lockstep engine ensures that clients of all players execute every other player's commands in the simulation on every machine in a synchronized manner or else the simulations will start to diverge and desync.

In an example, only user inputs that are received from the server 403 for each lockstep frame are processed, User inputs not included for the lockstep frame, even if intended for the lockstep frame, can be ignored or associated with another lockstep frame. In an example, each user input received by the server 403 is associated with a lockstep frame. For example, the user input information received by the server 403 includes a lockstep frame identifier and one or more user inputs. When user input information that includes a lockstep frame identifier is received outside a time interval for the identified lockstep frame, the user input information may be ignored or associated with another lockstep frame that is associated with a time interval in which the user input information is received.

At step 410, the client 401 may suffer from poor internet connection and experience lag or disconnect from the match. However, due to the server 403 understanding the specifics of the RTS game as it relates to timing for each turn (e.g., when a frame or time slice has ended), if the server 403 does not obtain any user inputs from the client 401 by the time the turn has ended, then the server 403 will treat the situation as if the client 401 had no inputs to give. Instead, the input of the client 401 is handled when it is received and processed on the appropriate game frame. In other words, the server 403 will transmit the current frame of user input information to all clients irrespective of whether a user input information is received from the disconnected client (e.g., client 401) within a current time interval. The result is that the disconnect client will not necessarily hold up the game for the rest of the users. Accordingly, the lagging or disconnected user is the only impacted party, which can vastly improve the multiplayer user experience for the other users.

The client 401 may have stable internet connection again and wishes to rejoin the game. At step 412, the client 401 may transmit a request to the server 403 to reconnect to the game. In response to the request to rejoin the match, the server 403 will retrieve cached inputs 414 from the session storage in memory 405. The server 403 may retrieve all cached inputs, game state information, and/or a combination of cached inputs and game state information. In an example, the game state information indicates a state of a game for a lockstep frame in view of the game inputs that have been processed up to that frame in the game.

At step 416, the session storage in memory 405 transmits a session input (e.g., all inputs from all users since the beginning of the game) to the server 403 and, at step 418, the server 403 will transmit the session input to the client 401 for catching up to a current frame. Specifically, the client 401 may process the session input from the match via the lockstep engine and render the plurality of video frames corresponding to the subset of the plurality of time intervals of the match in the video game based on the processed user inputs. In some examples, the session input comprises compressed user input information that includes the user inputs performed during the match. The session input does not require a large amount of data because only inputs are sent. In some examples, the session input may be as small as 200 kilobytes.

In some examples, in response to a new connection (e.g., previously disconnected user or new spectator) joining a pre-existing game session, the server 403 may retrieve a previous state of game state information from the session storage in memory 405 and send the previous state of game state information to the connection such that the client may reconstruct the game to its current state. The game state information may include one or more of player user inputs and/or game state associated with at least one time point of the video game. As the game executes within a game engine on the client 401, the game engine generates game state that is accessible through an API to allow a view model to translate it into visuals for the game. As described herein, the game state is associated with a frame and time it happened.

In an aspect, the server 403 stores game state information such as game information, unit information, and inputs for one or more frames, and, in one example, every single frame, directly. This allows users (e.g., disconnected users or spectators) to quickly join or rejoin a match after it has started by bypassing the game engine and using the game state information directly by the view model. When a frame corresponding to a current frame is not available, game state information of a most recent frame may be input directly and supplemented by subsequent user inputs to more quickly reconstruct the current frame. In some examples, the game state may have a file size as small as 50 kilobytes.

The game state information may include information for each of a plurality of time intervals of the lockstep game engine. In some examples, a game state information may refer to a current configuration of a game at a given point in time. This may include all of the information necessary to specify the game, such as the position of all of the game pieces, the health of the game pieces, the ability of the game pieces, the players' turns, and any other relevant variables. The game state information may change over time as the game progresses and actions are taken by the players. In some examples, the game state information may also include information about past events and actions that have taken place as this can affect the current state of the game and the available options for future moves. The game state information can be used to rejoin a game, or join a game after it begins, as discussed above.

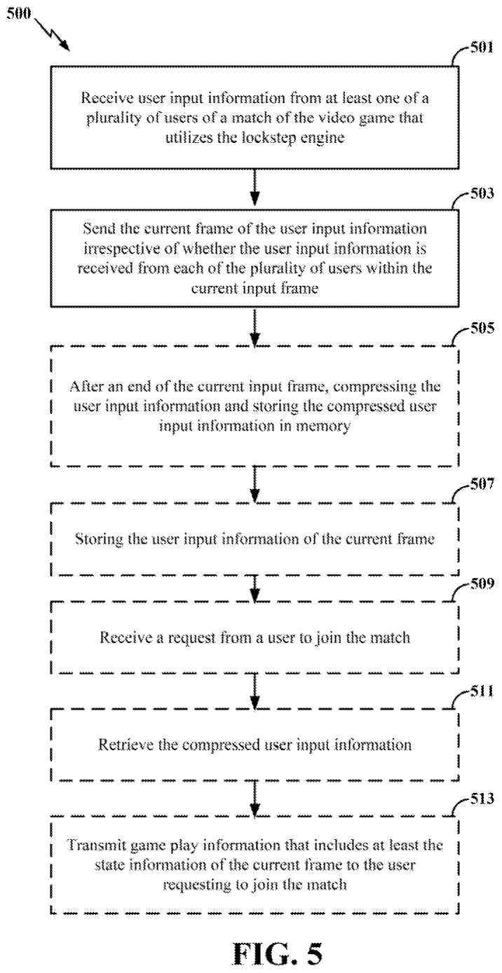

FIG. 5 is a flowchart of a method of a video game utilizing a lockstep engine in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein. Optional aspects are illustrated in dashed lines.

In FIG. 5, the method 500 may be performed by an apparatus, such as the server (server (e.g., server 305 shown in FIG. 5, server 403 shown in FIG. 4), as described above. In some implementations, the method 500 is performed by processing logic (e.g., processing circuitry), including hardware, firmware, software, or a combination thereof. In some implementations, the method 500 is performed by a processor executing code stored in a non-transitory computer-readable storage medium (e.g., a memory). The method 500 includes improving a multiplayer user experience of a video game utilizing a lockstep engine at a computing device.

At block 501, the method 500 may include receiving user input information from at least one of a plurality of users of a match of the video game that utilizes the lockstep engine. Each of the user input information from the at least one of the plurality of users being associated with a current frame of a plurality of frames of the lockstep engine based on the respective user input information being received within a current time interval of the current frame.

In some examples, the user input information from the at least one of the plurality of users may only include the user input information from a subset of the plurality of users. A benefit of this is that no single client can hold up the game by not entering their inputs. As a result, if any client is lagging or having internet connection issues, they are the only impacted party.

In some examples, the user input information from the at least one of the plurality of users may include user input information from one of the plurality of users that is associated with the current frame and received after the current time interval of the current frame and the user input information from the one of the plurality of users may be associated with a subsequent frame of the plurality of frames of the lockstep engine that corresponds to a subsequent time interval in which the user input information from the one of the plurality of users is received.

At block 503, the method 500 may include sending the current frame of the user input information irrespective of whether the user input information is received from each of the plurality of users within the current time interval.

At block 505, the method 500 may include, after an end of the current time interval, compressing the user input information as game state information in memory for reproducing a game state by processing the compressed user input information via the lockstep engine.

At block 507, the method 500 may include storing the user input information of the current frame.

At block 509, the method 500 may include receiving a request from a user to join the match. In some examples, the match is a live match that is in progress. As an example, referring back to FIG. 4, a client 401 that was previously disconnected may transmit a request to reconnect a match in progress.

At block 511, the method 500 may include retrieving the stored user input information. As an example, referring back to FIG. 4, the server 403 may retrieve cached inputs 414 from a session storage in memory 405. The server 403 may retrieve all cached inputs 414. In an example, the server 403 may retrieve a subset of the cached inputs 414 if game state information for a preceding lockstep frame is available, for example.

At block 513, the method 500 may include transmitting game state information that includes at least the user input information of the current frame to the user requesting to join the match. In some examples, the game state information indicates user inputs performed from a beginning of the match to a current frame of the match. As an example, referring back to FIG. 4, the server 403 may transmit a session input to the client 401 to reconnect to the match at a current frame.

In some examples, the method 500 may further include storing game state information of the current frame, the game state information including status information of game elements for the current frame; receiving a request from a user to join the match, retrieving the stored game state information, and transmitting the game state information to a client device of the user requesting to join the match, wherein the game state information processed by a view model to render a current video frame

In some examples, the method 500 may include obtaining snapshots of current game state information from the plurality of users at regular intervals; indexing the snapshots of game state information by time; and in response to a user requesting to join the match, transmitting a request to the plurality of users to transmit current state information to the user requesting to join the match, wherein the current state information is obtained using the indexed snapshots. The snapshots of the state in memory may be used as a basis point to continue the game from when a client joins. As such, in response to a client requesting to connect to a match in progress, the server can request the current state from all clients in the match and sends it to the client. Thus, the method 500 may further reduce the time it takes to catch up to the current point in the match at the cost of memory and bandwidth to the clients in the game. In some examples, depending on how long the game is running, this method may be less than sending the client the session of player inputs from the beginning of the game.

In some examples, the video game is real-time strategy (RTS) game.

It is understood that the method illustrated by FIG. 5 is exemplary in nature and that the steps described herein may be combined or modified to generate alternative aspects.

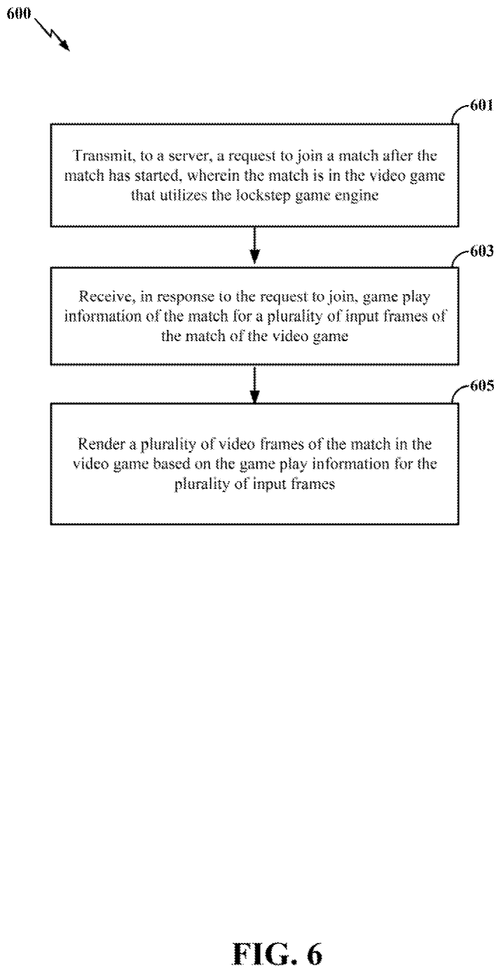

FIG. 6 is a flowchart of a method of a video game utilizing a lockstep engine in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein. Optional aspects are illustrated in dashed lines.

In FIG. 6, the method 600 may be performed by an apparatus, such as the computing device 100, as described above. In some implementations, the method 600 is performed by processing logic (e.g., processing circuitry), including hardware, firmware, software, or a combination thereof. In some implementations, the method 600 is performed by a processor executing code stored in a non-transitory computer-readable storage medium (e.g., a memory). The method 600 includes improving a multiplayer user experience of a video game utilizing a lockstep engine at a computing device.

At block 601, the method 600 may include transmitting, to a server, a request to join a match after the match has started. The match may be a video game that utilizes the lockstep game engine. In some examples, the request to join the match may be transmitted by a user participating in the match as a spectator. In some examples, the request to join the match may be transmitted by a user that was disconnected from the match. As an example, referring back to FIG. 4, the client 401 may be disconnected while the match is in progress and may request to reconnect to the match.

In some examples, the match of the video game may be a live match that is in progress.

At block 603, the method 600 may include, receiving, in response to the request to join, game state information of the match for a plurality of time intervals of the match of the video game. The game state information may include information for each of a plurality of time intervals of the lockstep game engine. In some examples, the plurality of time intervals includes each time interval of the match of the video game that elapsed before the request to join is received by the server.

At block 605, the method 600 may include rendering a plurality of video frames of the match in the video game based on the game state information for each of the plurality of time intervals.

In some examples, the game state information may indicate user inputs for each of at least a subset of the plurality of time intervals of the match and rendering of the plurality of video frames may include processing the user inputs from the match via the lockstep game engine, and rendering the plurality of video frames corresponding to the subset of the plurality of time intervals of the match in the video game based on the processed user inputs. In some examples, the game state information may include compressed user input information that includes user inputs performed during the match. As an example, referring back to FIG. 4, the client 401 may receive a session input from the server 403 and process the session input via the lockstep game engine to join the match at a current frame.

In some examples, the game state information may indicate a game state including status information of a plurality of game elements for each of at least a first subset of the plurality of time intervals of the match and the rendering the plurality of frames may include rendering the plurality of video frames corresponding to the first subset of the plurality of time intervals of the match in the video game based on the game state of each of the first subset of the plurality of time intervals of the match.

In some examples, the game state information may include status information of a plurality of game elements that is processed by a view model to render a current video frame of the plurality of video frames. In some examples, the game state information of the match may be stored in a cloud server and the game state information for each of the plurality of time intervals may be loaded from the cloud server.

In some examples, since an entire game state (e.g., rules, configurations, unit data information) is managed by a server (and not on the clients), the server may perform live updates, or change the rules of a game without the client having to download a client patch. In addition, the server may also dynamically the rules of the game while a match is in progress.

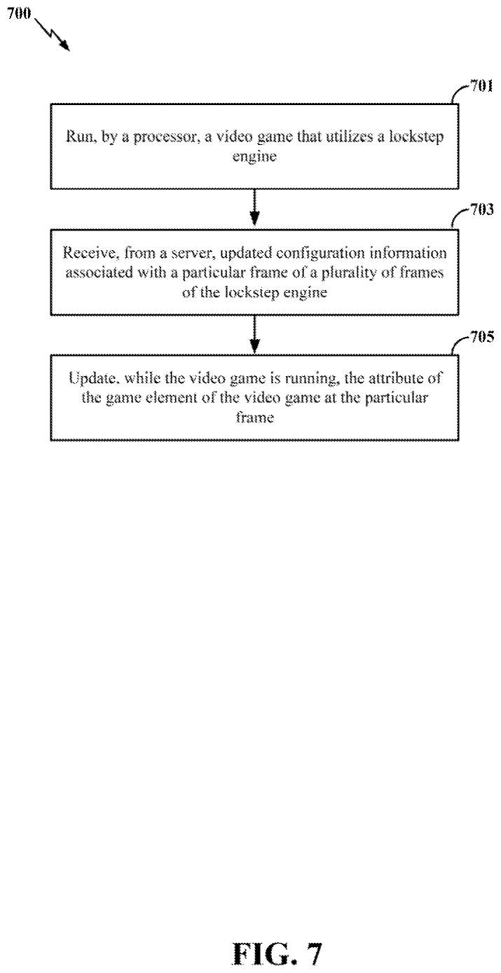

FIG. 7 is a method of live updating game data during a match in a video game in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein. Optional aspects are illustrated in dashed lines.

In FIG. 7, the method 700 may be performed by an apparatus, such as the computing device 100, as described above. In some implementations, the method 700 is performed by processing logic (e.g., processing circuitry), including hardware, firmware, software, or a combination thereof. In some implementations, the method 700 is performed by a processor executing code stored in a non-transitory computer-readable storage medium (e.g., a memory). The method 700 includes live updating game data during a match in a video game at a computing device.

At block 701, the method 700 may include running, by a processor, a video game that utilizes a lockstep engine.

At block 703, the method 700 may include receiving, from a server, updated configuration information associated with a particular frame of a plurality of frames of the lockstep engine. The updated configuration information may include a change to an attribute of a game element of the video game at the particular frame.

In some examples, the updated configuration information may be transmitted according to a scheduled time.

In some examples, receiving the updated configuration information may include receiving, from the server, the updated configuration information during a match of the video game and sending game state information comprising the updated configuration information to update the attribute of the game element of the video game during the match based on the updated configuration information.

In some examples, the updated configuration information may include at least one of an updated rule, updated configuration data, or updated virtual unit attribute data. In some examples, an updated rule may include game speed or change in main objective.

In some examples, the updated configuration information further includes global configuration information, game modifiers, list of graphic labels, attack modifiers for the virtual units, state modifiers for the virtual units, status effects for the virtual units, abilities for the virtual units, and attribute data for the virtual units, wherein the attribute data for the virtual units comprises at least at least one of size information, supply cost information, health information, turning radius information, speed information, vision information, or ability information.

At block 705, the method 700 may include updating, while the video game is running, the attribute of the game element of the video game at the particular frame.

Although the present disclosure is explained in the context of a an RTS game utilizing a lockstep engine, the subject matter described herein may be implemented across any video game that utilizes a lockstep engine and has a framework with independent pieces (e.g., game server, view model, and/or game engine) that work together to minimize dependencies on the amount of data and state required to re-create game state for any given moment in time.

The subject matter described herein can be implemented to realize one or more benefits. For instance, the techniques disclosed herein enable a method of improving a multiplayer user experience in a video game that utilizes a lockstep engine. This reduces the possibility of users adversely impacting the experience of other users due to not having a stable internet connection or by purposefully withholding inputs. As a result, clients no longer need to be in the game at the same time for the game to proceed, which means that users may easily disconnect and reconnect to rejoin a match that is already in progress without impacting the other users. Using the same video game architecture, users can also spectate any other matches that have begun in real-time.

In addition, using the live updating techniques disclosed, video game developers may update game data while the match is still running and have those updates reflected immediately without the clients having to restart the game or download a client patch to receive the updates. This may be particularly useful for video game developers to drop into live games at will to see what is happening in real time and move much quicker during development by identifying problems and bugs and easily share those findings with each other. As an example, due to the video game architecture, video game developers may update game data while a match is running, and have the updates reflected immediately without having to restart anything such that any developers on the team may instantly iterate any piece they need to. As another example, if the video game developers ever need to patch the game (or correct any game data as applied to configurations, rules, or units), then the updates may be sent dynamically to clients during a match without requiring the clients to restart the match or download a client patch. In addition, video game developers may use the same video game architecture to experiment with alternative game modes with minimal effort.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing unit may be implemented in hardware (e.g., by processing circuitry), software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware.

What is claimed is:

1. A method of a video game utilizing a lockstep engine, the method comprising:
receiving user input information from at least one of a plurality of users of a match of the video game that utilizes the lockstep engine, each of the user input information from the at least one of the plurality of users being associated with a current frame of a plurality of frames of the lockstep engine based on the respective user input information being received within a current time interval of the current frame; and
sending the current frame of the user input information irrespective of whether the user input information is received from each of the plurality of users within the current time interval.

2. The method of claim 1, wherein the user input information from the at least one of the plurality of users only includes the user input information from a subset of the plurality of users.

3. The method of claim 1, wherein
the user input information from the at least one of the plurality of users includes user input information from one of the plurality of users that is associated with the current frame and received after the current time interval of the current frame, and
the user input information from the one of the plurality of users is associated with a subsequent frame of the plurality of frames of the lockstep engine that corresponds to a subsequent time interval in which the user input information from the one of the plurality of users is received.

4. The method of claim 1, further comprising:
after an end of the current time interval, compressing the user input information and storing the compressed user input information in memory.

5. The method of claim 1, further comprising:
storing the user input information of the current frame;
receiving a request from a user to join the match;
retrieving the stored user input information; and
transmitting game state information that includes at least the user input information of the current frame to the user requesting to join the match.

6. The method of claim 5, wherein the game state information indicates user inputs performed from a beginning of the match to a current frame of the match.

7. The method of claim 1, further comprising:
storing game state information of the current frame, the game state information including status information of game elements for the current frame;
receiving a request from a user to join the match;
retrieving the stored game state information; and
transmitting the game state information to a client device of the user requesting to join the match, wherein the game state information is processed by a view model to render a current video frame.

8. The method of claim 5, wherein the match is a live match that is in progress.

9. The method of claim 1, further comprising:
obtaining snapshots of current game state information from the plurality of users at regular interval;
indexing the snapshots of game state information by time; and
in response to a user requesting to join the match, transmitting a request to the plurality of users to transmit game state information to the user requesting to join the match, wherein the current game state information is obtained using the indexed snapshots.

10. The method of claim 1, wherein the video game is a real-time strategy (RTS) game.

11. A method of a video game utilizing a lockstep engine, the method comprising:
transmitting, to a server, a request to join a match after the match has started, wherein the match is in the video game that utilizes the lockstep game engine;
receiving, in response to the request to join, game state information of the match for a plurality of time intervals of the match of the video game, the game state information comprising information for each of a plurality of time intervals of the lockstep game engine; and
rendering a plurality of video frames of the match in the video game based on the game state information for each of the plurality of time intervals.

12. The method of claim 11, wherein the match of the video game is a live match that is in progress.

13. The method of claim 11, wherein the plurality of time intervals includes each time interval of the match of the video game that elapsed before the request to join is received by the server.

14. The method of claim 11, wherein
the game state information indicates user inputs for each of at least a subset of the plurality of time intervals of the match, and
the rendering of the plurality of video frames comprises:
processing the user inputs from the match via the lockstep game engine, and
rendering the plurality of video frames corresponding to the subset of the plurality of time intervals of the match in the video game based on the processed user inputs.

15. The method of claim 14, wherein the game state information comprises compressed user input information that includes user inputs performed during the match.

16. The method of claim 11, wherein
the game state information indicates a game state including status information of a plurality of game elements for each of at least a first subset of the plurality of time intervals of the match, and
the rendering of the plurality of video frames comprises rendering the plurality of video frames corresponding to the first subset of the plurality of time intervals of the match in the video game based on the game state of each of the first subset of the plurality of time intervals of the match.

17. The method of claim 11, wherein the game state information comprises status information of a plurality of game elements that is processed by a view model to render a current video frame of the plurality of video frames.

18. The method of claim 11, wherein the game state information of the match is stored in a server.

19. The method of claim 11, wherein the request to join the match is transmitted by a user participating in the match as a spectator.

20. The method of claim 11, wherein the request to join the match is transmitted by a user that was disconnected from the match.

21. A method of receiving a video game update, the method comprising:
running, by a processor, a video game that utilizes a lockstep engine;
receiving, from a server, updated configuration information associated with a particular frame of a plurality of frames of the lockstep engine, the updated configuration information including a change to an attribute of a game element of the video game at the particular frame; and
updating, while the video game is running, the attribute of the game element of the video game at the particular frame.

22. The method of claim 21, wherein the receiving the updated configuration information comprises:
receiving, from the server, the updated configuration information during a match of the video game; and
sending game state information comprising the updated configuration information to update the attribute of the game element of the video game during the match based on the updated configuration information.

23. The method of claim 22, wherein the updated configuration information includes at least one of an updated rule, updated configuration data, or updated virtual unit attribute data.

24. The method of claim 23, wherein the updated configuration information further includes global configuration information, game modifiers, list of graphic labels, attack modifiers for the virtual units, state modifiers for the virtual units, status effects for the virtual units, abilities for the virtual units, and attribute data for the virtual units, wherein the attribute data for the virtual units comprises at least one of size information, supply cost information, health information, turning radius information, speed information, vision information, or ability information.

25. An apparatus for a video game utilizing a lockstep engine, the apparatus comprising:
processing circuitry configured to:
receive user input information from at least one of a plurality of users of a match of the video game that utilizes the lockstep engine, each of the user input information from the at least one of the plurality of users being associated with a current frame of a plurality of frames of the lockstep engine based on the respective user input information being received within a current time interval of the current frame; and
send the current frame of the user input information irrespective of whether the user input information is received from each of the plurality of users within the current time interval.

26. The apparatus of claim 25, wherein the user input information from the at least one of the plurality of users only includes the user input information from a subset of the plurality of users.

27. The apparatus of claim 25, wherein
the user input information from the at least one of the plurality of users includes user input information from one of the plurality of users that is associated with the current frame and received after the current time interval of the current frame, and
the user input information from the one of the plurality of users is associated with a subsequent frame of the plurality of frames of the lockstep engine that corresponds to a subsequent time interval in which the user input information from the one of the plurality of users is receive.

28. The apparatus of claim 25, wherein the processing circuitry is further configured to:
after an end of the current time interval, compressing the user input information and storing the compressed user input information in memory.

29. The apparatus of claim 25, wherein the processing circuitry is further configured to:
store the user input information of the current frame;
receive a request from a user to join the match;
retrieve the stored user input information; and
transmit game state information that includes at least the user input information of the current frame to the user requesting to join the match.

30. The apparatus of claim 29, wherein the game state information indicates user inputs performed from a beginning of the match to a current frame of the match.

31. The apparatus of claim 25, wherein the processing circuitry is further configured to:
store game state information of the current frame, the game state information including status information of game elements for the current frame;
receive a request from a user to join the match;
retrieve the stored game state information; and
transmit the game state information to a client device of the user requesting to join the match, wherein the game state information that is processed by a view model to render a current video frame.

32. The apparatus of claim 29, wherein the match is a live match that is in progress.

33. The apparatus of claim 25, wherein the processing circuitry is further configured to:
obtain snapshots of current game state information from the plurality of users at regular interval;
index the snapshots of game state information by time; and
in response to a user requesting to join the match, transmit a request to the plurality of users to transmit game state information to the user requesting to join the match, wherein the current game state information is obtained using the indexed snapshots.

34. The apparatus of claim 25, wherein the video game is a real-time strategy (RTS) game.

35. An apparatus for a video game utilizing a lockstep engine, the apparatus comprising:
processing circuitry configured to:
transmit, to a server, a request to join a match after the match has started, wherein the match is in the video game that utilizes the lockstep game engine;
receive, in response to the request to join, game state information of the match for a plurality of time intervals of the match of the video game, the game state information comprising information for each of a plurality of time intervals of the lockstep game engine; and
render a plurality of video frames of the match in the video game based on the game state information for each of the plurality of time intervals.

36. The apparatus of claim 35, wherein the match of the video game is a live match that is in progress.

37. The apparatus of claim 35, wherein the plurality of time intervals includes each time interval of the match of the video game that elapsed before the request to join is received by the server.

38. The apparatus of claim 35, wherein
the game state information indicates user inputs for each of at least a subset of the plurality of time intervals of the match, and
the rendering of the plurality of video frames comprises:
processing the user inputs from the match via the lockstep game engine, and
rendering the plurality of video frames corresponding to the subset of the plurality of time intervals of the match in the video game based on the processed user inputs.

39. The apparatus of claim 38, wherein the game state information comprises compressed user input information that includes user inputs performed during the match.

40. The apparatus of claim 35, wherein
the game state information indicates a game state including status information of a plurality of game elements for each of at least a first subset of the plurality of time intervals of the match, and
the rendering of the plurality of video frames comprises rendering the plurality of video frames corresponding to the first subset of the plurality of time intervals of the match in the video game based on the game state of each of the first subset of the plurality of time intervals of the match.

41. The apparatus of claim 35, wherein the game state information comprises status information of a plurality of game elements that is processed by a view model to render a current video frame of the plurality of video frames.

42. The apparatus of claim 35, wherein the game state information of the match is stored in a server.

43. The apparatus of claim 35, wherein the request to join the match is transmitted by a user participating in the match as a spectator.

44. The apparatus of claim 35, wherein the request to join the match is transmitted by a user that was disconnected from the match.

45. An apparatus for receiving a video game update, the apparatus comprising:
processing circuitry configured to:
run, by the processing circuitry, a video game that utilizes a lockstep engine;
receive, from a server, updated configuration information associated with a particular frame of a plurality of frames of the lockstep engine, the updated configuration information including a change to an attribute of a game element of the video game at the particular frame; and
update, while the video game is running, the attribute of the game element of the video game at the particular frame.

46. The apparatus of claim 45, wherein the receiving the updated configuration information comprises:
receiving, from the server, the updated configuration information during a match of the video game; and
sending game state information comprising the updated configuration information to update the attribute of the game element of the video game during the match based on the updated configuration information.

47. The apparatus of claim 46, wherein the updated configuration information includes at least one of an updated rule, updated configuration data, or updated virtual unit attribute data.

48. The apparatus of claim 47, wherein the updated configuration information further includes global configuration information, game modifiers, list of graphic labels, attack modifiers for the virtual units, state modifiers for the virtual units, status effects for the virtual units, abilities for the virtual units, and attribute data for the virtual units, wherein the attribute data for the virtual units comprises at least one of size information, supply cost information, health information, turning radius information, speed information, vision information, or ability information.

49. A non-transitory computer-readable storage medium storing computer-readable instructions thereon, which, when executed by processing circuitry, cause the processing circuitry to perform a method of a video game utilizing a lockstep engine, the method comprising:
receiving user input information from at least one of a plurality of users of a match of the video game that utilizes the lockstep engine, each of the user input information from the at least one of the plurality of users being associated with a current frame of a plurality of frames of the lockstep engine based on the respective user input information being received within a current time interval of the current frame; and
sending the current frame of the user input information irrespective of whether the user input information is received from each of the plurality of users within the current time interval.

50. The non-transitory computer-readable storage medium according to claim 49, wherein the user input information from the at least one of the plurality of users only includes the user input information from a subset of the plurality of users.

51. The non-transitory computer-readable storage medium according to claim 49, wherein
the user input information from the at least one of the plurality of users includes user input information from one of the plurality of users that is associated with the current frame and received after the current time interval of the current frame, and
the user input information from the one of the plurality of users is associated with a subsequent frame of the plurality of frames of the lockstep engine that corresponds to a subsequent time interval in which the user input information from the one of the plurality of users is received.

52. The non-transitory computer-readable storage medium according to claim 49, the method further comprising:
after an end of the current time interval, compressing the user input information and storing the compressed user input information in memory.

53. The non-transitory computer-readable storage medium according to claim 49, the method further comprising:
storing the user input information of the current frame;
receiving a request from a user to join the match;
retrieving the stored user input information; and
transmitting game state information that includes at least the user input information of the current frame to the user requesting to join the match.

54. The non-transitory computer-readable storage medium according to claim 53, wherein the game state information indicates user inputs performed from a beginning of the match to a current frame of the match.

55. The non-transitory computer-readable storage medium according to claim 49,
the method further comprising:
storing game state information of the current frame, the game state information including status information of game elements for the current frame;
receiving a request from a user to join the match;
retrieving the stored game state information; and
transmitting the game state information to a client device of the user requesting to join the match, wherein the game state information processed by a view model to render a current video frame.

56. The non-transitory computer-readable storage medium according to claim 55, wherein the match is a live match that is in progress.

57. The non-transitory computer-readable storage medium according to claim 53, the method further comprising:
obtaining snapshots of current game state information from the plurality of users at regular interval;
indexing the snapshots of game state information by time; and
in response to a user requesting to join the match, transmitting a request to the plurality of users to transmit game state information to the user requesting to join the match, wherein the current game state information is obtained using the indexed snapshot.

58. The non-transitory computer-readable storage medium according to claim 49, wherein the video game is a real-time strategy (RTS) game.

59. A non-transitory computer-readable storage medium storing computer-readable instructions thereon, which, when executed by processing circuitry, cause the processing circuitry to perform a method of a video game utilizing a lockstep engine, the method comprising:
transmitting, to a server, a request to join a match after the match has started, wherein the match is in the video game that utilizes the lockstep game engine;
receiving, in response to the request to join, game state information of the match for a plurality of time intervals of the match of the video game, the game state information comprising information for each of a plurality of time intervals of the lockstep game engine; and
rendering a plurality of video frames of the match in the video game based on the game state information for each of the plurality of time intervals.

60. The non-transitory computer-readable storage medium according to claim 59, wherein the match of the video game is a live match that is in progress.

61. The non-transitory computer-readable storage medium according to claim 59, wherein the plurality of time intervals includes each time interval of the match of the video game that elapsed before the request to join is received by the server.

62. The non-transitory computer-readable storage medium according to claim 59, wherein
the game state information indicates user inputs for each of at least a subset of the plurality of time intervals of the match, and
the rendering of the plurality of video frames comprises:
processing the user inputs from the match via the lockstep game engine, and
rendering the plurality of video frames corresponding to the subset of the plurality of time intervals of the match in the video game based on the processed user inputs.

63. The non-transitory computer-readable storage medium according to claim 62, wherein the game state information comprises compressed user input information that includes user inputs performed during the match.

64. The non-transitory computer-readable storage medium according to claim 59, wherein
the game state information indicates a game state including status information of a plurality of game elements for each of at least a first subset of the plurality of time intervals of the match, and
the rendering of the plurality of video frames comprises rendering the plurality of video frames corresponding to the first subset of the plurality of time intervals of the match in the video game based on the game state of each of the first subset of the plurality of time intervals of the match.

65. The non-transitory computer-readable storage medium according to claim 59, wherein the game state information comprises status information of a plurality of game elements that is processed by a view model to render a current video frame of the plurality of video frames.

66. The non-transitory computer-readable storage medium according to claim 59, wherein the game state information of the match is stored in a server.

67. The non-transitory computer-readable storage medium according to claim 59, wherein the request to join the match is transmitted by a user participating in the match as a spectator.

68. The non-transitory computer-readable storage medium according to claim 59, wherein the request to join the match is transmitted by a user that was disconnected from the match.

69. A non-transitory computer-readable storage medium storing computer-readable instructions thereon, which, when executed by processing circuitry, cause the processing circuitry to perform a method of receiving a video game update, the method comprising:
running, by a processor, a video game that utilizes a lockstep engine;
receiving, from a server, updated configuration information associated with a particular frame of a plurality of frames of the lockstep engine, the updated configuration information including a change to an attribute of a game element of the video game at the particular frame; and
updating, while the video game is running, the attribute of the game element of the video game at the particular frame.

70. The non-transitory computer-readable storage medium according to claim 69, wherein the receiving the updated configuration information comprises:
receiving, from the server, the updated configuration information during a match of the video game; and
sending game state information comprising the updated configuration information to update the attribute of the game element of the video game during the match based on the updated configuration information.

71. The non-transitory computer-readable storage medium according to claim 70, wherein the updated configuration information includes at least one of an updated rule, updated configuration data, or updated virtual unit attribute data.

72. The non-transitory computer-readable storage medium according to claim 71, wherein the updated configuration information further includes global configuration information, game modifiers, list of graphic labels, attack modifiers for the virtual units, state modifiers for the virtual units, status effects for the virtual units, abilities for the virtual units, and attribute data for the virtual units, wherein the attribute data for the virtual units comprises at least one of size information, supply cost information, health information, turning radius information, speed information, vision information, or ability information.
